(19) United States
(12) Patent Application Publication
(10) Pub. No.: US 2009/0254277 A1
(43) Pub. Date: Oct. 8, 2009

(54) Powered transmitter for railroad car applications

(75) Inventors: John S. Davey, Bolingbrook, IL (US); Alex V. Degutis, East Chicago, IN (US); Michael S. Ryan, Darien, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Salco Products, Inc., Lemont, IL (US)

(21) Appl. No.: 12/080,307

(22) Filed: Apr. 2, 2008

(51) Int. Cl. G01C 21/00

(52) U.S. Cl. 701/213

(57) ABSTRACT

A system to report the position and/or measured conditions of a railroad car using satellite communication. The system includes a rechargeable power supply and communications unit incorporating one or more solar cells in combination with a rechargeable battery and further including a bank of ultracapacitors. The equivalent series resistance or “ESR” of the capacitor bank is substantially less than the ESR of the battery thereby allowing peak power demands to be filled by rapid dissipation of stored charge from the capacitor bank without substantial involvement of the battery under normal conditions.

### TECHNICAL FIELD

The present invention is directed generally to systems for reporting the position and/or condition of railroad cars. More particularly, it is directed to a rechargeable power unit in combination with a transceiver in communication with a global positioning system and/or one or more sensor units adapted to monitor various conditions in a railroad car. The power unit is adapted to be rechargeable using solar power and to transmit and receive data using a transceiver powered using stored energy from a solar cell.

### BACKGROUND OF THE INVENTION

Railroad car location tracking systems utilizing global positioning technology are known. Such systems are used to allow the owner of the railroad car to monitor the location of the car at any given time. As will be appreciated, knowledge of the position and/or load condition of a railroad car may be an important element in the transportation of perishable goods. Moreover, the ability to monitor the location of the railroad car may provide an added element of security when transporting potentially hazardous materials.

Past systems have utilized combinations of solar cells and rechargeable batteries to provide necessary operating power to the units. However, such systems may require fairly substantial periods of time to recharge and may fail to hold the charge at an operable level after a relatively low number of recharge cycles. Specifically, after several hundred recharging cycles, the battery systems may be incapable of holding a charge necessary to operate the unit and the batteries must be replaced. The present invention addresses this deficiency by providing a power system which utilizes solar power as the recharging source and which is capable of undergoing several hundred thousand recharging cycles without substantial degradation of storage potential.

### BRIEF SUMMARY OF THE INVENTION

A system is provided to report the position and/or measured conditions of a railroad car using satellite communication. The reporting system includes a rechargeable power supply and communications unit incorporating one or more solar cells in combination with one or more rechargeable batteries and further including a bank of ultracapacitors. The ultracapacitors are arranged in parallel with the rechargeable batteries to power a GPS transceiver and one or more optional sensors adapted to monitor conditions within the railroad car. The equivalent series resistance or “ESR” of the capacitor bank is substantially less than the ESR of the batteries thereby allowing peak power demands to be filled by rapid dissipation of stored charge from the capacitor bank without substantial involvement of the batteries under normal conditions. The stored charge of the batteries may be accessed secondarily if required. The capacitor bank is self-balancing thereby eliminating the need for balancing resistors within the capacitor bank. The absence of such balancing resistors further reduces the ESR and promotes the preferential power drain from the capacitor bank relative to the batteries.

### BRIEF DESCRIPTION OF THE DRAWINGS

The following drawings which are incorporated in and which constitute a part of this specification, illustrate exemplary embodiments and constructions of the present invention and, together with the general description given above and the detailed description set forth below, serve to explain the principles of the invention wherein:

FIG. 1 is a diagram of a global positioning and data communications system adapted for communicating location and/or status data between a railroad car and a monitoring unit;

FIG. 2 illustrates a power circuit for energizing a transceiver and optional status sensors used in the system of FIG. 1; and

FIG. 3 is a logic diagram setting forth exemplary operational steps of firmware associated with the system of FIG. 1 utilizing the power system of FIG. 2.

While the invention has been illustrated and described above and will hereinafter be described in connection with certain potentially preferred embodiments and procedures, it is to be understood that in no event is the invention to be limited to such illustrated and described embodiments and procedures. On the contrary, it is intended that the present invention shall extend to all alternatives and modifications to the illustrated and described embodiments and procedures as may embrace the broad principles of this invention within the true spirit and scope thereof.

### DETAILED DESCRIPTION OF EXEMPLARY EMBODIMENTS

Various embodiments of the invention pertain to the use of a global positioning satellite system to monitor and report the position and/or one or more measured conditions of a railroad car. Solar power is used as the energy source for powering a transceiver mounted at the railroad car to communicate and receive data. Solar power may also be used as the energy source to operate various optional sensors and other equipment. An arrangement of one or more one rechargeable batteries in combination with a self-balancing bank of ultracapacitors is used to satisfy peak power demands while permitting multiple rechargeable cycles over an extended life for the system.

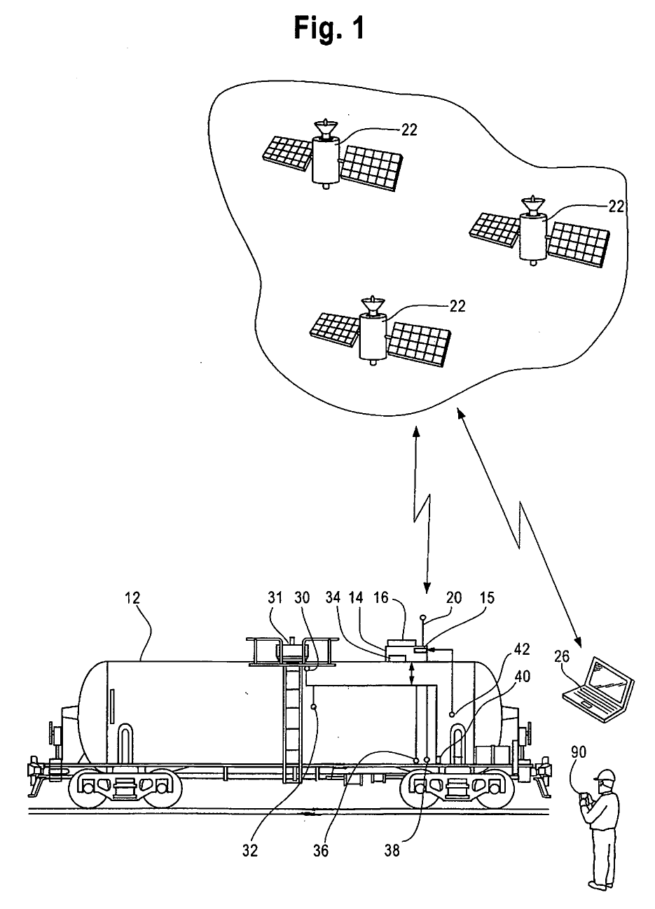

Referring now to the drawings, FIG. 1 illustrates generally major components of a monitoring and reporting system for a railroad car 12. In FIG. 1, the railroad car 12 such as a tank car, hopper car or the like, is fitted with a power supply and communications unit 14. The power supply and communications unit 14 is powered using energy supplied by one or more solar cells 16 mounted across the surface. As shown, the power supply and communications unit 14 includes a GPS unit 15 and a transceiver 20 adapted to send and receive digital data signals using an array of satellites 22. This transmittal and receipt of digital data permits communication with a remote monitoring and control unit 26. The monitoring and control unit 26 may be used to download position and other data as transmitted by the transceiver 20. The monitoring and control unit 26 may also be utilized to transmit command data to the power supply and communications unit 14 so as to adjust operating parameters as may be desired.

As illustrated schematically in FIG. 1, the power supply and communications unit 14 may be operatively connected to one or more sensors or other units which are powered by energy collected using the solar cells 16. By way of example only, and not limitation, various sensors operatively connected to the power supply and communications unit 14 may include a hatch status sensor 30 monitoring the open or closed position of a hatch 31 or other access opening, a temperature sensor 32, an accelerometer 34, a load sensor 36, an air brake pressure sensor 38, and a hand brake pressure sensor 40. Each of these sensors may be powered using energy supplied by the solar cell 16 and stored in the power supply and communications unit 14 in the manner as will be described further hereinafter. Likewise, conditions monitored by such sensors may be communicated back to the power supply and communications unit 14 for subsequent transmission using transceiver 20. The power supply and communications unit 14 may also be adapted to receive data from one or more self-powered auxiliary units. By way of example only, one such self-powered auxiliary unit is a chemical sniffer 42 which utilizes a self-contained power source. Of course, any number of other independently powered or dependently powered auxiliary units may also be utilized if desired.

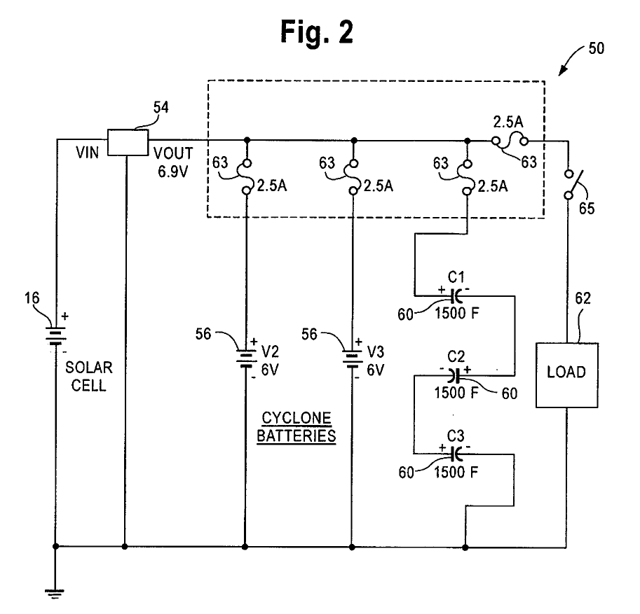

In operation, the power supply and communications unit 14 includes an arrangement of power storage devices adapted to collect and retain power from the solar cells 16 and to periodically power the transceiver 20 to transmit databursts to provide location and status data to the monitoring and control unit 26 using the satellites 22. An exemplary power collection and storage system 50 for use in the power supply and communications unit 14 is illustrated in FIG. 2. The illustrated power collection and storage system 50 provides an adequate power reserve to satisfy peak loads during transmittal of databursts using the transceiver 20. The power collection and storage system 50 also permits multiple recharging cycles without storage capacity degradation.

In the illustrated arrangement, the power collection and storage system 50 utilizes a six-volt solar cell 16 as the regenerative power supply source. A buck regulator 54 is used to provide an output voltage of 6.9 volts. As shown, the power collection and storage system 50 incorporates a pair of rechargeable six-volt batteries 56 in parallel with one another and with a bank of ultracapacitors 60 to power the load 62 corresponding to the cumulative demands of the transceiver 20 and various powered auxiliary units such as sensors and the like as may be utilized. In this regard, although the illustrated construction uses two batteries 56, it is likewise contemplated that a greater or lesser number of batteries may be used if desired. Fuses 63 for each, circuit leg are arranged in encapsulated relation within a potting compound with access by a fuse holder 65.

As shown, the ultracapacitors 60 are connected in series with one another and with the bank of such ultracapacitors 60 being arranged in parallel with the batteries 56 and the load 62. In the illustrated arrangement, the bank of ultracapacitors 60 incorporates three ultracapacitors arranged in series with each rated at 1500 Farads. In the exemplary construction each ultracapacitor 60 is rated at 2.7 volts for a total of 8.1 volts. However, the total voltage across the ultracapacitors is limited to 6.9 volts coming out of the regulator 54. As shown, the illustrated arrangement is free of voltage equalizing resistors across the individual ultracapacitors 60. Thus, the resistor bank is self-balancing. This self-balancing arrangement permits the equivalent series resistance or “ESR” of the capacitor bank to be held at an extremely low level thereby facilitating rapid discharge from the bank of ultracapacitors during periods of peak load demand.

As will be appreciated, ultracapacitors are similar to common electrolytic capacitors in that they each have small internal resistance which, in turn, induces only slight inefficiencies to their operation. However, ultracapacitors are capable of providing a very large capacitance which is orders of magnitude greater than that provided by electrolytic capacitors of similar size. Further, ultracapacitors exhibit substantially no electrochemical inefficiencies during charging and discharging and exhibit little, if any degradation after multiple charging and discharging cycles.

As will be appreciated, the load 62 will be at a peak during periods of databurst transmission by the transceiver 20. By way of example only, such databursts are typically 6 bytes, each containing 8 bits of information. During this peak transmission load, power will be drawn from the ultracapacitors 60. Due to the low ESR rating of the capacitor bank, power is pulled almost exclusively from the ultracapacitors 60 without involvement of the batteries 56. However, in the event that the ultracapacitors 60 are incapable of satisfying the load demand, the batteries 56 may be utilized. During periods between data transmission, the ultracapacitors may be recharged using the regenerative trickle charge provided by solar cells 16. In the event that solar cells 16 are unavailable due to damage and/or darkness, the ultracapacitors 60 may be recharged using the batteries 56 until such time as the solar cell 16 may become available.

As will be appreciated, due to the substantial lack of involvement by the batteries 56, they are normally held in a maintenance mode without substantial charge depletion. Thus, the batteries 56 typically do not experience substantial charge reduction and do not undergo a significant number of recharging cycles. Accordingly, since the ultracapacitors are not prone to degradation as a result of recharging, there is little if any degradation in the recharging capacity of the entire system even following multiple cycles of peak loading and subsequent regeneration.

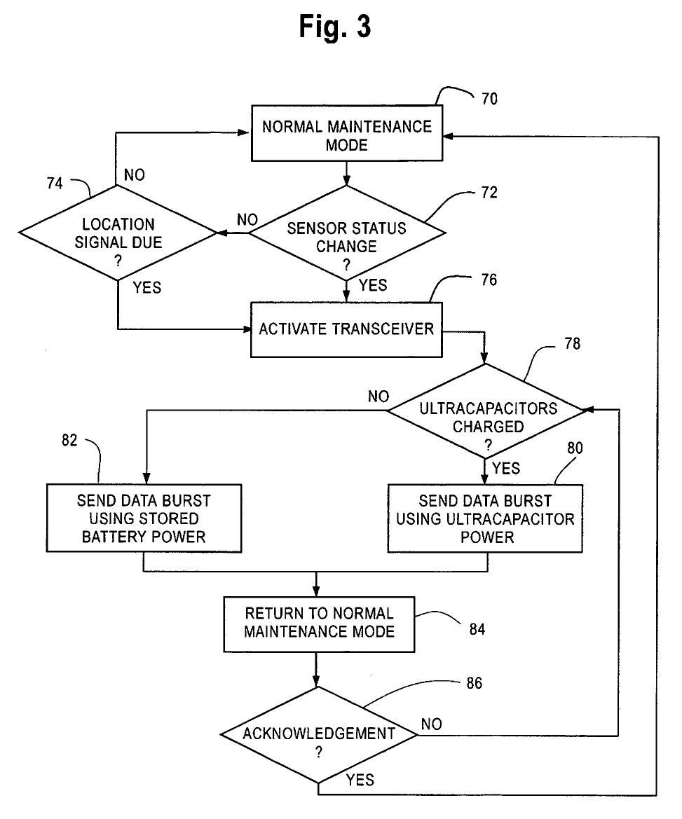

The benefits of the power collection and storage system 50 may be enhanced by utilization of a control system or firmware which efficiently utilizes available power to provide the desired periodic transmission of data. By way of example only, and not limitation, FIG. 3 illustrates a high level logic diagram for operation of the power supply and communications unit 14. As shown, the system is normally held in a maintenance mode 70 wherein the solar cell 16 feeds a regenerative trickle charge to the ultracapacitors 60 and to the batteries 56. During the maintenance mode 70 the load 62 is at a low demand level merely providing maintenance power to the system and to any powered sensors or other auxiliary units as may be present. During the maintenance mode 70, the firmware monitors for a sensor status change 72 and/or a pre-scheduled location reporting requirement 74. In the event that a sensor status has changed and/or a location report is due, the transceiver 20 is activated as shown at block 76 for transmission of a databurst via satellites 22 for receipt by the monitoring and control unit 26 as shown in FIG. 1. In the event that the ultracapacitors are charged as shown at block 78, the data burst of position and/or sensor condition data is sent to a satellite 22 using power supplied by the ultracapacitors 60 as shown at block 80. Alternatively, in the event that the ultracapacitors 60 are not charged, the databurst of position and/or sensor condition data is sent to the satellite 22 using stored battery power as shown at block 82. Of course, the ultracapacitors 60 and the batteries 56 may also be used conjunctively if required. Following the databurst transmission by transceiver 20, the transceiver 20 thereafter returns to normal maintenance mode as shown at block 84 and awaits an acknowledgement of data receipt by the monitoring and control unit 26 as indicated at logic block 86. In the event that the acknowledgement is received, the system maintains the maintenance mode. However, if no acknowledgement is received, the transmission sequence is repeated after a fixed period of time until the transmission is successfully sent and acknowledged.

As indicated previously, the power supply and communications unit 14 may be operatively connected to a number of auxiliary sensors or other units including a hatch status sensor 30, a temperature sensor 32, an accelerometer 34, a load sensor 36, an airbrake pressure sensor-38, a handbrake pressure sensor 40, a chemical sniffer 42, and other devices as may be desired. In accordance with contemplated practices, such auxiliary units may be operated in a manner consistent with the power collection and storage system 50 as previously described so as to facilitate relatively low power load requirements during normal operation while nonetheless permitting the communication of sensor status data in the event of a status change.

According to one contemplated practice, the hatch status sensor 30 monitors the open or closed status of a hatch 31 or other access opening in the railroad car 12. By way of example only, and not limitation, in one embodiment the hatch status sensor 30 may be in the form of a circuit which is open when the hatch 31 is in an open condition and which is closed when the hatch 31 is in a closed position. A voltage pulse is applied across the circuit at pre-established intervals. In the event that two consecutive pulses indicate a status change from open to closed or from closed to open, that result is communicated to the power supply and communications unit 14 for transmission to the monitoring and control unit 26. In this regard, by requiring at least two consecutive measurements of status change, the propensity for false indications arising as a result of natural movement of the railroad car are substantially reduced.

The temperature sensor 32 which is utilized is typically a high/low sensor which sends an accurate temperature reading with each transmission. In addition, the temperature sensor 32 transmits a status change when the temperature exceeds a level outside a predefined range. Thus, naturally occurring temperature variations as may occur as a result of changes in climate and altitude during use of the railroad car 12 are not reported as a status change, while temperature levels indicative of dangerous conditions are readily communicated to the power supply and communications unit 14.

The load sensor 36 may be positioned between a bolster and a cross member of the railroad car side frame. The load sensor 36 monitors the change in distance between these surfaces as an indicator of load. If the load sensor measures a change from a full car to an empty car or from an empty car to a full car, a status change is reported to the power supply and communications unit 14.

If desired, a common voltage pulse may be used to monitor the temperature sensor 32 and the load sensor 36. By way of example, a voltage pulse may be carried out every 30 seconds or at such other interval as may be desired. In the event that two consecutive pulses indicate a reportable status change in either the temperature sensor 32 or in the load sensor 36, the status change is reported to the power supply and communications unit 14.

An accelerometer 34 may be mounted at the power supply and communications unit 14 and used to monitor for collision and/or derailment events. In the event that an accelerometer 34 is utilized, it may be configured to provide a continuous voltage signal under normal conditions. The circuit is broken in the event that the railroad car 12 experiences predefined levels of acceleration change in either the direction aligned with the railroad car 12 or in the direction transverse to the railroad car 12. Such levels are set to reflect collision and/or roll-over events. In the event that these pre-established levels are exceeded, the continuous voltage is terminated thereby reflecting a status change which is communicated by the power supply and communications unit 14 to the monitoring and control unit 26.

In the event that a chemical sniffer 42 is utilized, a similar monitoring system may be used wherein the sniffer provides a constant voltage which is normally monitored at the power supply and communications unit 14. Upon detection of a pre-defined chemical exceeding a specified concentration level, the voltage is terminated. The termination of the voltage thus indicates a status change which is reported by the power supply and communications unit 14 to the monitoring and control unit 26.

Of course, additional auxiliary systems may also be utilized if desired. By way of example only, and not limitation, according to one contemplated practice, the power supply and communications unit 14 may include a Bluetooth chip to facilitate communications between the power supply and communications unit 14 and a local monitoring and control unit 90 such as a hand-held device operated by a technician or safety personnel. According to one contemplated practice, such a Bluetooth chip would be normally unpowered, but would be activated either by a control unit such as the remote monitoring and control unit 26 or the localized monitoring and control unit 90 so as to permit a download of all available information. It is also contemplated that such a Bluetooth chip may be activated automatically upon indication of accelerometer status change so as to permit safety personnel to readily access all available information upon responding to a collision or roll-over event.

As will be appreciated, regardless of the configuration of sensors or other auxiliary units as may be utilized, the power collection and storage system 50 may be used to efficiently satisfy both maintenance power requirements as well as peak power requirements as may be demanded. Moreover, such a power collection and storage system 50 is completely regenerative without the propensity for degradation after multiple recharging cycles. Thus, the system according to the present invention may be used for extended periods relying only on solar power to provide an adequate power supply.

It is to be understood that the use of any and all examples, or exemplary language provided herein, is intended merely to better illuminate the invention and does not pose a limitation on the scope of the invention unless otherwise claimed. No language in the specification should be construed as indicating any non-claimed element as essential to the practice of the invention. Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A solar powered data reporting system adapted to be mounted on a railroad car for periodic digital data burst transmission of position status information from said railroad car to a remote monitoring unit using satellite transmission, the data reporting system comprising:
a portable transceiver adapted to transmit bursts of digital data delivered to a satellite system;
a portable global positioning sensor monitoring the location of said railroad car, said portable global positioning sensor being in operative communication with said portable transceiver for the transmittal of location data to said satellite system;
a remote monitoring unit adapted to download said location data from said satellite system; and
a solar power collection and storage system operatively connected to said portable transceiver, said power collection and storage system including at least one solar cell adapted to charge at least one rechargeable battery and a bank of ultracapacitors, said bank of ultracapacitors being arranged in parallel with said at least one rechargeable battery, said bank of ultracapacitors being free from balancing resistors, said bank of ultracapacitors having an equivalent series resistance less than said at least one rechargeable battery such that power demands for said portable transceiver are drawn preferentially from said ultracapacitors relative to said at least one rechargeable battery.

2. The solar powered data reporting system as recited in claim 1, further including at least one auxiliary sensor monitoring a condition other than location of said railroad car, said at least one auxiliary sensor being in operative communication with said portable transceiver for transmission of sensor status data to said satellite system.

3. The solar powered data reporting system as recited in claim 2, wherein said at least one auxiliary sensor comprises a hatch status sensor monitoring an access opening within the railroad car.

4. The solar powered data reporting system as recited in claim 3, wherein said hatch status sensor is powered by said solar power collection and storage system.

5. The solar powered data reporting system as recited in claim 2, wherein said at least one auxiliary sensor comprises a temperature sensor monitoring for temperatures beyond a predefined range.

6. The solar powered data reporting system as recited in claim 5, wherein said temperature sensor is powered by said solar power collection and storage system.

7. The solar powered data reporting system as recited in claim 2, wherein said at least one auxiliary sensor comprises a load sensor monitoring for load change conditions from full to empty or from empty to full.

8. The solar powered data reporting system as recited in claim 7, wherein said load sensor is powered by said solar power collection and storage system.

9. The solar powered data reporting system as recited in claim 2, wherein said at least one auxiliary sensor comprises an accelerometer monitoring for changes in acceleration beyond predefined ranges.

10. The solar powered data reporting system as recited in claim 9, wherein said accelerometer is powered by said solar power collection and storage system.

11. The solar powered data reporting system as recited in claim 2, wherein said at least one auxiliary sensor comprises a chemical sniffer monitoring for concentrations of one or more chemicals beyond predefined levels.

12. The solar powered data reporting system as recited in claim 11, wherein said chemical sniffer is self powered.

13. The solar powered data reporting system as recited in claim 1, further comprising a satellite-free communications link adapted to interface with a local monitoring and control unit.

14. The solar powered data reporting system as recited in claim 1, wherein said solar cell is not greater than a 6 volt cell and said at least one rechargeable battery is not greater than a 6 volt battery.

15. The solar powered data reporting system as recited in claim 1, wherein said at least one rechargeable battery is adapted to provide at least a portion of the power demands to said portable transceiver and said global positioning sensor in the event of a deficiency in the power supply from said ultracapacitors.

16. The solar powered data reporting system as recited in claim 15, wherein said at least one rechargeable battery is adapted to recharge said bank of ultracapcitors when said at least one solar cell is inactive.

17. A solar powered data reporting system adapted to be mounted on a railroad car for periodic digital data burst transmission of position and sensor condition status information from said railroad car to a remote monitoring unit using satellite transmission, the data reporting system comprising:
a portable transceiver adapted to transmit bursts of digital data delivered to a satellite system;
a portable global positioning sensor monitoring the location of said railroad car, said portable global positioning sensor being in operative communication with said portable transceiver for the transmittal of location data to said satellite system;
at least one auxiliary sensor monitoring a condition other than location of said railroad car, said at least one auxiliary sensor being in operative communication with said portable transceiver for transmission of sensor status data to said satellite system;
a remote monitoring unit adapted to download said location data and said sensor status data from said satellite system; and
a solar power collection and storage system operatively connected to said portable transceiver, said power collection and storage system including at least one solar cell adapted to charge at least a pair of rechargeable batteries and a bank of at least three ultracapacitors, said bank of at least three ultracapacitors being arranged in parallel with said batteries, said bank of at least three ultracapacitors being free from balancing resistors, said bank of at least three ultracapacitors having an equivalent series resistance less than said batteries such that power demands for said portable transceiver are drawn preferentially from said ultracapacitors relative to said batteries.

18. The solar powered data reporting system as recited in claim 17, wherein said batteries are adapted to provide at least a portion of the power demands to said portable transceiver, said portable global positioning sensor and said at least one auxiliary sensor in the event of a deficiency in the power supply from said ultracapacitors.

19. The solar powered data reporting system as recited in claim 18, wherein said batteries are adapted to recharge said ultracapcitors when said at least one solar cell is inactive.

20. A solar powered data reporting system adapted to be mounted on a railroad car for periodic digital data burst transmission of position and sensor condition status information from said railroad car to a remote monitoring unit using satellite transmission, the data reporting system comprising:
a portable transceiver adapted to transmit bursts of digital data delivered to a satellite system;
a portable global positioning sensor monitoring the location of said railroad car, said portable global positioning sensor being in operative communication with said portable transceiver for the transmittal of location data to said satellite system;
at least one power dependent auxiliary sensor monitoring a condition other than location of said railroad car, said at least one power dependent auxiliary sensor being in operative communication with said portable transceiver for transmission of sensor status data to said satellite system said at least one power dependent auxiliary sensor selected from the group consisting of a hatch status sensor, a temperature sensor, a load sensor, an accelerometer, and combinations thereof;
a remote monitoring unit adapted to download said location data and said sensor status data from said satellite system; and
a solar power collection and storage system operatively connected to said portable transceiver and to said at least one power dependent auxiliary sensor, said power collection and storage system including at least one solar cell adapted to charge at least a pair of rechargeable batteries and a bank of at least three ultracapacitors, said bank of at least three ultracapacitors being arranged in parallel with said batteries, said bank of at least three ultracapacitors being free from balancing resistors, said bank of at least three ultracapacitors having an equivalent series resistance less than said batteries such that power demands for said portable transceiver, said portable global positioning sensor and said at least one power dependent auxiliary sensor are drawn preferentially from said ultracapacitors relative to said batteries, said batteries being adapted to provide at least a portion of the power demands to said portable transceiver, said portable global positioning sensor and said at least one power dependent auxiliary sensor in the event of a deficiency in the power supply from said ultracapacitors, and said batteries being adapted to recharge said ultracapcitors when said at least one solar cell is inactive.
